(19) United States
(12) Patent Application Publication
(10) Pub. No.: US 2025/0306598 A1
(43) Pub. Date: Oct. 2, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: SHOZO YOSHIMURA, Kanagawa (JP); MASAKAZU FUJIKI, Kanagawa (JP)

(21) Appl. No.: 19/086,911

(22) Filed: Mar. 21, 2025

(30) Foreign Application Priority Data
Mar. 27, 2024 (JP) 2024-050947

(51) Int. Cl. G05D 1/622

(52) U.S. Cl. CPC G05D 1/622

(57) ABSTRACT

An information processing apparatus includes at least one memory storing a program, and at least one processor that when executing the program causes the information processing apparatus to acquire at least one plan assigned to at least one autonomous mobile object, detect, based on the at least one plan, an obstruction factor that is likely to cause an obstruction to execution of the at least one plan, predict the obstruction with respect to the at least one plan based on the at least one plan and the obstruction factor, determine a modification content for the at least one plan based on the obstruction, and update the at least one plan based on the modification content.

### BACKGROUND

### Field

The present disclosure relates to an autonomous movement control technique and a work management technique for a mobile object.

### Description of the Related Art

In recent years, mobile robots, automated guided vehicles (AGVs), and other types of mobile object have become widely used, and are used to convey items and execute other tasks in place of humans. In execution of a task by a mobile object, the task execution may be hindered by an obstacle on a route traveled by the mobile object. Japanese Patent Application No. 2016-033029 discloses a technique for, if an obstacle interferes with a route of a mobile object, avoiding the obstacle by changing the route plan for the mobile object.

The technique disclosed in Japanese Patent Application No. 2016-033029 changes the route plan without considering the mobile object's influence on the route plan, which can reduce its work efficiency.

### SUMMARY

According to an aspect of the present disclosure, an information processing apparatus includes at least one memory storing a program, and at least one processor that when executing the program causes the information processing apparatus to acquire at least one plan assigned to at least one autonomous mobile object, detect, based on the at least one plan, an obstruction factor that is likely to cause an obstruction to execution of the at least one plan, predict the obstruction with respect to the at least one plan based on the at least one plan and the obstruction factor, determine a modification content for the at least one plan based on the obstruction, and update the at least one plan based on the modification content.

Further features of the present disclosure will become apparent from the following description of exemplary embodiments with reference to the attached drawings.

### BRIEF DESCRIPTION OF THE DRAWINGS

FIG. 1 is a diagram illustrating a scene in which a mobile object equipped with an information processing apparatus travels on a passage.

FIG. 2 is a block diagram illustrating a configuration example of the information processing apparatus.

FIG. 3 is a block diagram illustrating an example of a hardware configuration of the information processing apparatus.

FIG. 4 is a flowchart illustrating a process executed by the information processing apparatus according to an exemplary embodiment.

### DESCRIPTION OF THE EMBODIMENTS

Exemplary embodiments will be described in detail with reference to the accompanying drawings. The following exemplary embodiments are not seen to be limiting. While a plurality of features is described in the exemplary embodiments, all of the features do not need to be used, while any combination of the plurality of features may be used. In the accompanying drawings, the same or similar components are denoted by the same reference numerals, and redundant description will be omitted.

A first exemplary embodiment will now be described. Examples of mobile objects include an autonomous mobile robot (AMR), an automated guided vehicle (AGV), an autonomous vehicle, a cleaning robot, and a drone. A mobile object is also referred to as an autonomous mobile object. In the present exemplary embodiment, an example of application to an AGV will be described.

In the present disclosure, an event that reduces the work efficiency when a task assigned to a mobile object is performed is referred to as an obstruction. Alternatively, an event that lowers the efficiency of execution of the plan when a plan assigned to a mobile object is executed is referred to as an obstruction. An event that causes an obstruction is referred to as an obstruction factor. For example, when a passage is blocked by a stack of items on the passage, the efficiency is reduced due to the extension of the travel distance by a mobile object taking a detour, and thus an obstruction “passage impassable” occurs. In this case, “the decrease in the passage width” due to the stack of items is the obstruction factor.

In the present exemplary embodiment, a task assigned to a mobile object is conveyance. An example will be described of predicting an event in which, in conveyance of items, the width of a passage is reduced due to an obstacle that exists on the conveyance route, which makes the conveyance impossible to change the time of traveling on the passage. The prediction is made by detecting decrease in the width of a passage using a Light Detection and Ranging (LiDAR) sensor mounted on the mobile object to predict an obstruction. An information processing apparatus according to the present exemplary embodiment uses a route plan with, as an element, time information as to when a mobile object will pass between points along a passage, in changing the plan. When the mobile object moves to take a detour, which increases the travel route, thus reducing the work efficiency. For this reason, in the task assigned to the mobile object, the step of passing through a passage is advanced or postponed, enabling the mobile object to perform the task with reduced decrease in its work efficiency.

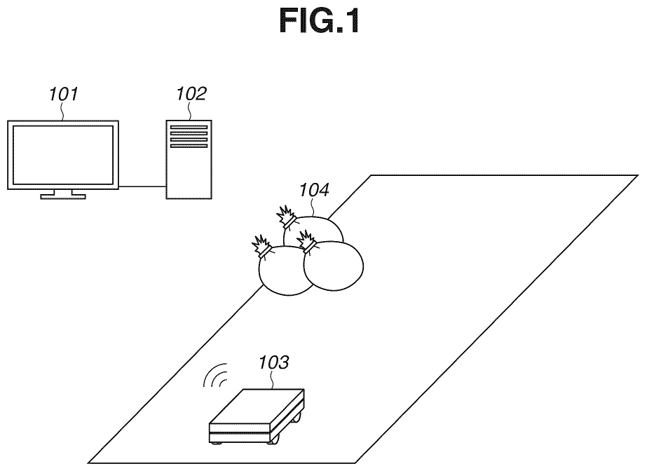

FIG. 1 is a diagram illustrating a mobile object 103 equipped with an information processing apparatus 200 traveling on a passage as an aspect of exemplary embodiments of the present disclosure. The information processing apparatus 200 detects an obstruction factor by measuring a passage width around obstacles 104 in FIG. 1 to detect a decrease in the passage width, and predicts obstruction to determine a modification scenario of the plan stored by a plan management system 102. An operator can check the modification content of the plan based on an output device 101.

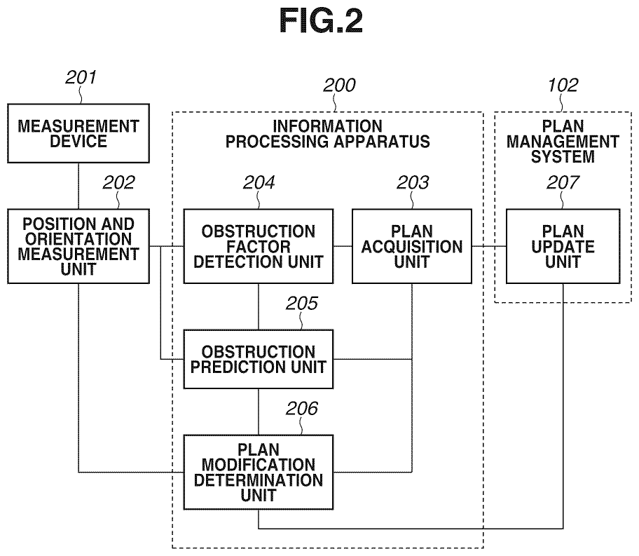

FIG. 2 is a block diagram illustrating a configuration example of an information processing system according to the present exemplary embodiment. The information processing apparatus 200 includes a plan acquisition unit 203, an obstruction factor detection unit 204, an obstruction prediction unit 205, and a plan modification determination unit 206. The information processing apparatus 200 determines a plan modification content based on a value or values measured by a measurement device 201 and a measurement result obtained via a position and orientation measurement unit 202. With respect to the modification content, a plan update unit 207 updates the plan stored by the plan management system 102.

The measurement device 201 is mounted on the mobile object 103. In the present exemplary embodiment, the measurement device 201 is an LiDAR sensor.

The position and orientation measurement unit 202 calculates either the position or the orientation, both, of the mobile object 103 equipped with the measurement device 201 based on the value(s) measured by the measurement device 201. In the present exemplary embodiment, both the position and the orientation are calculated as position and orientation measurement values. The position and orientation measurement unit 202 generates a two dimensional map representing the position(s) of an object or objects that is/are present in the environment in which the mobile object 103 operates, the object(s) of which will be an obstacle or obstacles to the operation of the mobile object 103. The measurement values of the position and the orientation are sent to the obstruction factor detection unit 204, and the position and the measurement values of the position and the orientation and the two dimensional map are sent to the obstruction prediction unit 205.

The plan acquisition unit 203 acquires information on a route plan assigned to the mobile object 103 from the plan update unit 207 and sends the information to the obstruction factor detection unit 204 and the obstruction prediction unit 205.

The obstruction factor detection unit 204 detects an obstruction factor in the operation environment of the mobile object 103 based on the measurement values obtained via the position and orientation measurement unit 202 mounted on the mobile object 103. The detected obstruction factor and a change rate of the obstruction factor are sent to the obstruction prediction unit 205 and the plan modification determination unit 206. The change rate is an amount of change per unit time at which an event serving as an obstruction factor changes. For example, the change rate of an obstruction factor of “decrease in passage width” is the rate at which the passage width decreases.

The obstruction prediction unit 205 predicts an obstruction that will occur based on the obstruction factor and the change rate of the obstruction factor acquired from the obstruction factor detection unit 204. The obstruction prediction unit 205 sends the obstruction content, the obstruction occurrence site, and the obstruction occurrence time to the plan modification determination unit 206. The obstruction content is an identifier of an event that causes the obstruction, and is an event name in the present exemplary embodiment. The obstruction occurrence time is the time at which the obstruction will occur.

The plan modification determination unit 206 determines a plan modification scenario that will reduce the influence of the obstruction based on the result predicted by the obstruction prediction unit 205. The determined modification scenario is sent to the plan update unit 207.

The plan update unit 207 updates the plan stored in an external holding unit according to the modification scenario determined by the plan modification determination unit 206.

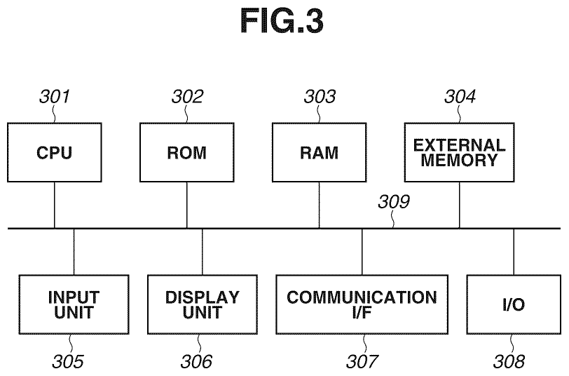

FIG. 3 is a block diagram illustrating an example of a hardware configuration of the information processing apparatus 200. The information processing apparatus 200 includes a central processing unit (CPU) 301 that controls various devices connected via a system bus 309. A read only memory (ROM) 302 stores a program of a Basic Input Output System (BIOS) and a boot program used by the information processing apparatus 200. A random access memory (RAM) 303 is used as a main storage device for the CPU 301. An external memory 304 stores programs and data processed by the information processing apparatus 200. A plan assigned to the mobile object 103 is also stored in the external memory 304.

An input unit 305 includes an input device for performing operations on a keyboard, a pointing device, a robot controller, buttons, and/or other devices, and information inputs. A display unit 306 displays results of arithmetic processing of the information processing apparatus 200 based on instructions of the CPU 301. The display unit 306 includes a display device, such as a liquid crystal display device, a projector, or a light-emitting diode (LED) indicator.

A communication interface (I/F) 307 unit performs information communications with external devices via, for example, networks. The communication I/F 307 performs communication via local area networks, universal serial buses (USB), such as serial communication and wireless communication, and the type of communication is not limited.

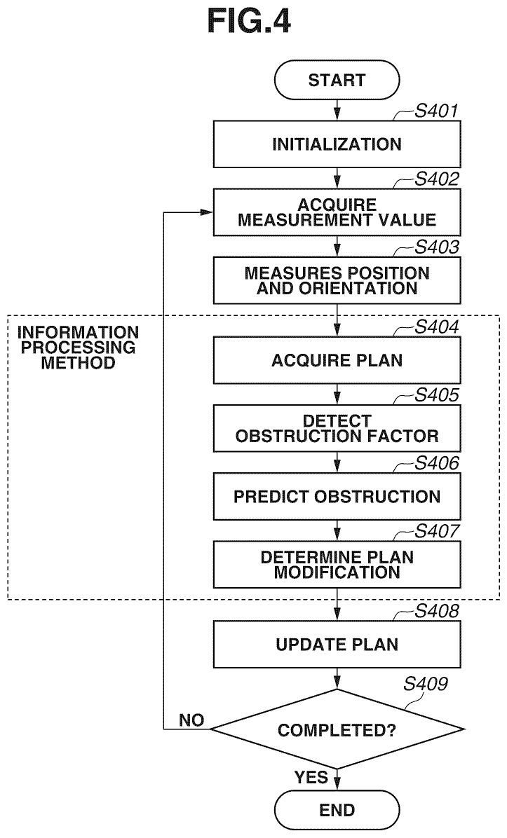

FIG. 4 is a flowchart illustrating an operation of the information processing apparatus 200. The following flowchart is carried out by the CPU 301 executing control programs.

The process described in FIG. 4 is automatically started when the information processing apparatus 200 is activated.

In step S401, the information processing apparatus 200 performs a system initialization.

Parameters stored in the ROM 302 of the sensor as the measurement device 201 mounted on the mobile object 103 and the memory used for calculation of the CPU 301 are also initialized. In the initialization process, data stored in the ROM 302 and/or the external memory 304 in advance are loaded into the RAM 303. The data to be loaded includes information on a minimum passage width Wm that enables the mobile object 103 to pass through. When the initialization process is finished, the processing proceeds to step S402.

In step S402, the measurement device 201 acquires a measurement value or values obtained by measuring the environment in which the mobile object 103 operates.

The acquired measurement value(s) is output to the position and orientation measurement unit 202. The processing then proceeds to step S403.

In step S403, the position and orientation measurement unit 202 measures the position and the orientation of the mobile object 103.

This operation involves measurement of the position and the orientation of the mobile object 103 by Simultaneous Localization and Mapping (SLAM) based on values of the LiDAR sensor as the measurement device 201. In the present exemplary embodiment, the position and orientation measurement results are expressed using coordinates in a two dimensional coordinate system fixed in the space in which the mobile object 103 travels.

Next, the position and orientation measurement unit 202 measures a two dimensional map generated based on scan information obtained by scanning a physical space from the position and orientation measurement results. The two dimensional map is an occupancy grid map, and the measurement device 201 generates an occupancy grid map by the method discussed by Grisetti et al. (Grisetti et al., “Improved Techniques for Grid Mapping with Rao-Blackwellized Particle Filters,” Trans. on Robotics 23.1 (2007)). The occupancy grid map is a map in which the environment is divided into a grid. Each grid cell indicates the presence of an obstacle with the presence represented by a numerical value from 0 to 1. The larger the numerical value, the higher the probability that the grid cell is occupied by the obstacle. The position and orientation measurement results and the occupancy grid map are output to the obstruction prediction unit 205, the position and orientation measurement results are output to the obstruction factor detection unit 204 and the plan modification determination unit 206, and the processing then proceeds to step S404.

In step S404, the plan acquisition unit 203 acquires a plan assigned to the mobile object 103 from the plan update unit 207.

In the present exemplary embodiment, the plan acquisition unit 203 acquires information on a route plan including information on coordinates of waypoints as points through which the mobile object 103 will pass and times at which the mobile object 103 will pass through the waypoints. The waypoints are represented in the same coordinate system as used in the position and orientation measurement of the mobile object 103. The plan acquisition unit 203 outputs the plan to the obstruction prediction unit 205 and the plan modification determination unit 206, and the processing then proceeds to step S405.

In step S405, the obstruction factor detection unit 204 detects an obstruction factor based on the measurement values.

The obstruction factor detection unit 204 acquires the position and orientation measurement values of the mobile object 103 calculated by the position and orientation measurement unit 202 while the mobile object 103 is traveling. Then, the obstruction factor detection unit 204 measures a passage width Wij at the corresponding waypoint in the route plan sent from the plan acquisition unit 203. The subscript “i” is a number for identifying the corresponding waypoint, and the subscript “j” indicates the number of times of passage measurement at each waypoint. The mobile object 103 measures a passage width at each waypoint, and stores the time of the measurement in the RAM 303 in association with the Wij. A passage width is a distance between two occupied areas that exist in the immediate vicinity to the left and right of the travel route of the mobile object 103 in the occupancy grid map of objects. The obstruction factor detection unit 204 compares the calculated passage width Wij with a passage width Wij−1 stored in the RAM 303 when the mobile object 103 previously passed through the waypoint. As a result of the comparison, if the passage width Wij at the time of the measurement is smaller than the passage width Wij−1, the event name of the obstruction factor as “decrease in passage width” is sent to the obstruction prediction unit 205. The obstruction factor detection unit 204 obtains the measurement time and a change rate Vi of the passage width at the point where the mobile object 103 has passed, based on the difference obtained by subtracting the Wij−1 from the passage width Wij in the comparison, and sends the measurement time and the change rate Vi to the obstruction prediction unit 205 together with the event name of the obstruction factor. The determination of the presence or absence of a decrease in passage width and the change rate of the passage width is not limited to being made using passage width information at two points in time, but may be made using passage width information at three or more points in time. The occupancy grid map is not necessarily used in the calculation of a passage width. It is sufficient to use information on an area occupied by an object on the passage. Information on an area occupied by an object is not necessarily used. A passage width may be calculated by measuring the size of an object group on the passage and subtracting the size from the passage width with no object present on the passage.

The obstruction factor detection unit 204 stores the passage width Wij at the point through which the mobile object 103 has passed in the RAM 303, and the processing then proceeds to step S406.

In step S406, the obstruction prediction unit 205 predicts an obstruction based on the obstruction factor.

In the present exemplary embodiment, the occurrence of an obstruction that will affect a task, the occurrence site of the obstruction, and the occurrence time of the obstruction are predicted based on an obstruction factor and a change rate Vi input from the obstruction factor detection unit 204. In the present exemplary embodiment, the obstruction prediction unit 205 refers to the change rate Vi at each waypoint, predicts the occurrence of an obstruction “passage impassable” at a point where the change rate Vi is less than zero and the obstruction factor of which the event name is “decrease in passage width”, and predicts “no obstruction” at a point where the change rate Vi is greater than or equal to zero.

The obstruction prediction unit 205 calculates, based on the passage width Wij and the change rate Vi of the passage, an obstruction occurrence time T at a waypoint at which the occurrence of the obstruction “passage impassable” is predicted. The obstruction occurrence time T is calculated using the following equation (1):

Ti=Tij−(Wij−Wm)/Vi equation (1)

where Tij is the time when the position and orientation measurement unit 202 measures a passage width at the i-th waypoint for the j-th time.

The obstruction prediction unit 205 outputs the obstruction content “passage impassable” and information on the obstruction occurrence site and the obstruction occurrence time to the plan modification determination unit 206, and the processing then proceeds to step S407.

In step S407, the plan modification determination unit 206 determines a plan modification scenario for the plan based on the obstruction content, the position and orientation measurement results of the mobile object 103, the obstruction occurrence time T, and the plan.

The plan modification determination unit 206 determines whether the mobile object 103 will pass through the obstruction occurrence site after the obstruction occurrence time based on the travel plan and the position and orientation measurement results. The plan modification determination unit 206 obtains the last time at which the mobile object 103 will pass through each waypoint that is an obstruction occurrence site. Thereafter, TDi is calculated by adding a predetermined time margin to the maximum value of the difference between the last time at which the mobile object will pass through each waypoint and the obstruction occurrence time at the corresponding waypoint. The plan modification scenario is determined by moving all the times included in the route plan forward by the maximum value of TDi.

The plan modification determination unit 206 outputs the plan modification scenario to the plan update unit 207, and then the processing proceeds to step S408.

In step S408, the plan update unit 207 updates the plan.

In the present exemplary embodiment, a new route plan is created based on the modification scenario input from the plan modification determination unit 206 and output to an external holding unit. After the output, the processing proceeds to step S409.

In step S409, it is determined whether to complete the operation. The processing according to the present exemplary embodiment is completed in response to when a command instructing the end of autonomous traveling of the mobile object 103 is input from the user via an input unit (not illustrated). With no end instruction issued, the processing of steps S402 to S409 continues.

As described above, in the first exemplary embodiment, if an obstacle affects a task assigned to the mobile object 103 in the future, the plan for the mobile object 103 is updated, improving the work efficiency.

### (First Modification 1)

In the present exemplary embodiment, the plan acquired by the plan acquisition unit 203 is a route plan for movement, but any plan may be used as long as the plan can reduce decrease in the work efficiency by changing the plan. For example, a task plan may include a task content, a task start point, and times. In a case of a task plan, the occurrence site of an obstruction as passage impassable and the time of the obstruction occurrence are predicted, and in a similar way, the entire task plan is moved forward so that the passage through the site is completed before the time of the obstruction occurrence.

### (First Modification 2)

In the present exemplary embodiment, the obstruction prediction unit 205 predicts the time when an obstruction occurs, but may predict a case alone where an obstruction will occur after the prediction time. An example will be described in which an obstruction occurs after a time obtained by measurement by the measurement device 201.

The obstruction factor detection unit 204 detects an obstruction factor alone in step S405 and sends the obstruction factor to the obstruction prediction unit 205.

The obstruction prediction unit 205 determines an obstruction content based on the obstruction factor input in step S406.

The determined obstruction content and the obstruction occurrence site are output to the plan modification determination unit 206, and the processing then proceeds to step S407.

The plan modification determination unit 206 determines a plan modification scenario based on the obstruction content, the obstruction occurrence site, and the plan in step S407. The plan modification scenario is determined in which times of the route plan are changed by a predetermined time. For example, all the times included in the route plan are advanced by one hour. The plan modification determination unit 206 enters the plan modification scenario into the plan update unit 207 and the processing then proceeds to step S408.

As described above, in the present modification, no obstruction occurrence time is calculated, and thus a plan is updated regardless of the prediction accuracy of an obstruction occurrence, improving the work efficiency.

### (First Modification 3)

In the present exemplary embodiment, a passage width is measured and a decrease in the passage width is detected every time the mobile object 103 passes through the passage. The method is not limited to the method according to the present exemplary embodiment as long as the method can detect a decrease in passage width. For example, a decrease in passage width may be detected by the passage width being successively measured by an LiDAR sensor installed in the passage.

An increase in the number of objects that are detected based on images captured by a camera or another similar device mounted on the mobile object 103 may be used to detect a decrease in passage width. The information processing apparatus 200 may detect a decrease in passage width based on the number of pixels occupied by an object on a screen. A decrease in passage width may be detected based on images captured by a camera installed in the passage, instead of one mounted on the mobile object 103.

In the present exemplary embodiment, a passage width is measured at each waypoint. The point at which a passage width is measured may be any point on the travel route as long as the time when the mobile object 103 will pass through the point can be predicted. The point may be any point between waypoints. Areas into which a passage is divided in a longitudinal direction may be used instead of points.

In the present exemplary embodiment, the obstruction factor detection unit 204 detects a decrease in passage width as an obstruction factor. However, any event that causes an obstruction may be detected. For example, “passage impassable” may be predicted by detecting water droplets from images captured by an imaging device, such as a camera, as the measurement device 201, and detecting an obstruction factor of “decrease in friction on the passage floor surface”, and by the obstruction prediction unit 205 predicting the “decrease in friction on the passage floor surface”. “Passage impassable” may be predicted by detecting an obstruction factor “passage congestion” when the density of persons on the passage is greater than or equal to a predetermined value. The obstruction content of “passage impassable” may be predicted by detecting a mat or a step on the passage to detect an obstruction factor “change in flatness of the passage floor surface”.

The input from the obstruction factor detection unit 204 is not limited to measurement values by the measurement device 201. Any data may be used that enables an obstruction factor to be detected. For example, railroad accident occurrence information input via the internet or another information source may be used to detect “passage congestion” as an obstruction factor, or “decrease in friction on the passage floor surface” may be detected based on weather forecast data, such as a probability of precipitation.

The present exemplary embodiment detects an obstruction factor that will occur along a passage, but the occurrence site is not limited to a passage. Any place may be chosen where an event that reduces the work efficiency of the mobile object 103 occurs.

For example, the obstruction factor may be detected as a decrease in friction on the floor surface of a warehouse where a conveyance item is unloaded from a cargo module during a conveyance task.

A plurality of types of obstruction factors may be detected rather than a single type of obstruction factor. This enables further reducing the likelihood of the work efficiency being reduced due to an obstruction.

In the present exemplary embodiment, “passage impassable” has been described as an example of an obstruction, but an obstruction may be any event that reduces the work efficiency. The obstruction content may be “passage difficulty”, such as a case where the travel speed needs to be reduced or the travel route needs to be changed, other than “passage impassable”. The obstruction content may be an event that disables the task from being performed due to, for example, the absence of any conveyance item in a conveyance task. In a case of the obstruction content of “passage difficulty”, the plan modification determination unit 206 determines a modification scenario to extend the time taken between the waypoints. A modification scenario to make the route meander may be determined.

By detecting an obstruction with a lower degree of reduction in the work efficiency, the reduction in the work efficiency can be further lowered.

A plurality of types of obstructions may be detected, other than a single type of obstruction, modifying the plan. This can further lower the reduction in the work efficiency.

A modification scenario in the present exemplary embodiment may be any measure to lower the reduction in the work efficiency of the task assigned to the mobile object 103. A time or times of the route plan may be postponed by a predetermined time. In order for the mobile object 103 not to pass through an occurrence site after the obstruction occurrence time, the plan may be postponed so that the mobile object 103 will not pass through the occurrence site until the obstruction that has occurred is removed.

A plan modification scenario may be determined by adding an operation plan for removing water droplets, a step, or another type of obstacle, all of which cause an obstruction.

In the present exemplary embodiment, a plan modification scenario in which all times included in the route plan are moved forward is determined. However, a plan modification scenario in which all times included in the route plan are moved backward may be determined.

A plan with a buffer period may be entirely shortened to prevent the mobile object 103 from passing through an occurrence site after the obstruction occurrence time. A plan without a buffer period may be entirely extended in anticipation of an additional time due to the occurrence of an obstruction. That is, the plan execution time does not include the obstruction occurrence time.

In the present exemplary embodiment, the task assigned to the mobile object 103 is a conveyance task. However, the task is not limited to conveyance. A task may be cleaning, security, or inventory. The above described determination method can be used as a method for determining a modification scenario in those other tasks.

If the task content is work on an area, such as cleaning, an obstruction factor detection and an obstruction prediction relating to the work area are made, instead of or in addition to relating to a predetermined point. In addition to the above-described types of obstructions, an obstruction subject to detection may be an “occupied work area” in which the work area is occupied for a purpose other than work of the mobile object 103, which disables the mobile object 103 from performing the task. Information used in detecting an obstruction factor can be either measurement data or non-measurement data, as described above.

A second exemplary embodiment will now be described. In the first exemplary embodiment, the method has been described of lowering a reduction in the work efficiency by modifying a route plan of a mobile object. In the present exemplary embodiment, a method will be described of lowering a reduction in the work efficiency by shortening the travel time of a route plan to increase the work to be completed before the occurrence of an obstruction.

The configuration of the information processing apparatus 200 of the second exemplary embodiment is the same as that of the first exemplary embodiment, and as such, a description thereof is omitted herein.

The processing of the second exemplary embodiment is substantially similar to the first exemplary embodiment, and as such, a detailed description is omitted herein. A difference from the first exemplary embodiment will be described with reference to the flowchart of FIG. 4. The start of the operation is the same as in the first exemplary embodiment.

In step S407, the plan modification determination unit 206 determines a plan modification scenario for the task plan for the mobile object 103 in the present exemplary embodiment.

In the present exemplary embodiment, the processing up to the process of determining whether the mobile object 103 will pass through an obstruction occurrence site by the plan modification determination unit 206 is the same as that of the first exemplary embodiment. Then, the plan modification determination unit 206 changes the route plan so that the mobile object 103 will not pass through the occurrence site after the obstruction occurrence time. The plan modification determination unit 206 searches the route plan for the mobile object 103 for the last time at which the mobile object 103 will pass through the waypoint that is the occurrence site. If the last time that has been obtained is later than the obstruction occurrence time, the time(s) taken between waypoints is shortened by a fixed factor λ. Here, λ is a number greater than zero and less than one, and the plan modification determination unit 206 sets a last time so that the last time at which the mobile object 103 will pass through the waypoint is earlier than the obstruction occurrence time. That is, the plan execution time does not include the obstruction occurrence time. The shortened result is proposed as the modification scenario for the route plan.

The plan modification determination unit 206 outputs the modification scenario for the route plan to the plan update unit 207, and the processing then proceeds to step S408.

As described above, in the present exemplary embodiment, if an obstacle affects a task assigned to a mobile object in the future, the work efficiency can be improved without changing the start time of the route plan.

In the present exemplary embodiment, the modification scenario is determined by the travel time being shortened by the plan modification determination unit 206. However, the modification scenario is not limited to shortening the travel time. Any modification scenario for a route plan may be used as long as the modification scenario improves the work efficiency, the modification scenario where the mobile object will not pass through an occurrence site after the obstruction occurrence time. For example, a modification scenario may be used in which the work efficiency is improved by changing a mechanism of unloading items, such as a holding unit mounted on a mobile object, to a mechanism whose operation speed is relatively high to change the time at which the mobile object will reach a waypoint after the work.

A work time may be shortened by sharing the work of a plurality of conveyance items from among a plurality of mobile objects to perform the work at the same time.

A modification scenario may be used in which the time at which a mobile object will arrive at a waypoint at which an obstruction will occur is changed by making a change of reducing the amount of conveyance items to reduce the work.

In the present exemplary embodiment, the mobile object to which the conveyance task is assigned has been described. However, the assigned task is not limited to the conveyance task. The task assigned to a mobile object may be cleaning. The modification scenario may include a change of changing the time at which the mobile object will arrive at a waypoint with a work efficiency improved by changing to a component or components that enables cleaning a wider range at once. The modification scenario may include a change of changing the time at which the mobile object will arrive at a waypoint by sharing cleaning from among a plurality of mobile objects or by not performing the cleaning in a part of the range.

A third exemplary embodiment will now be described. In the first exemplary embodiment, the method has been described of lowering the reduction in the work efficiency by avoiding an obstruction that will occur. In the present exemplary embodiment, a method will be described of lowering the reduction in the work efficiency without avoiding an obstruction that will occur.

In the present exemplary embodiment, an example will be described in which a plurality of mobile objects to which a conveyance task is assigned share the task by transferring items over an obstruction occurrence site at which the passage is disabled, lowering the reduction in the work efficiency. That is, an example of adding an execution subject will be described.

The configuration of the information processing apparatus 200 in the present exemplary embodiment is the same as that of the first exemplary embodiment, and a detailed description thereof is omitted herein.

The processing of the present exemplary embodiment is substantially similar to that of the first exemplary embodiment, and a detailed description is omitted herein. A difference from the first exemplary embodiment will be described with reference to the flowchart of FIG. 4. The start of the operation is the same as in the first exemplary embodiment.

In step S404, the plan acquisition unit 203 acquires task plans respectively assigned to a plurality of mobile objects 103. In the present exemplary embodiment, all the task plans for the plurality of mobile objects 103 managed by the plan management system 102 are acquired. The plan acquisition unit 203 outputs the task plans for the plurality of mobile objects 103 to the obstruction prediction unit 205, and the processing then proceeds to step S405.

In step S406, the obstruction prediction unit 205 predicts an obstruction based on an obstruction factor.

In the present exemplary embodiment, an obstruction content is predicted based on the obstruction factor input from the obstruction factor detection unit 204. If the obstruction factor is “decrease in passage width”, the obstruction prediction unit 205 acquires “passage impassable”. The obstruction prediction unit 205 outputs the obstruction content to the plan update unit 207, and then the processing then proceeds to step S408.

In step S407, the plan modification determination unit 206 determines modification scenarios for the task plans based on the obstruction content, the obstruction occurrence site, the time, and the task plans. In the present exemplary embodiment, the task plans input in the plan modification determination unit 206 and the modification scenarios for the task plans output from the plan modification determination unit 206 are assigned to the plurality of mobile objects 103.

The plan modification determination unit 206 determines the modification scenarios for the task plans based on the tasks assigned to the plurality of mobile objects 103. In the present exemplary embodiment, the task plans for the two mobile objects 103, each provided with an automatic loading/unloading mechanism for items are extracted. The plan modification determination unit 206 then determines the modification scenarios for the task plans so that the plurality of mobile objects 103 to which the extracted task plans are respectively assigned will transfer conveyance items at the obstruction site. In the present exemplary embodiment, the task plans are modified so that one mobile object will perform unloading of the conveyance items from its cargo module at the waypoint that is the obstruction site, and the other mobile object will perform loading of the conveyance items onto its cargo module at the same waypoint. The plan modification determination unit 206 then outputs the plan modification scenarios to the plan update unit 207, and the processing then proceeds to step S408.

The subsequent processing is the same as that of the first exemplary embodiment, and a detailed description is omitted herein.

As described above, in the present exemplary embodiment, if an obstacle affects a task assigned to a mobile object in the future, task plans for a plurality of mobile objects are updated without avoiding the obstruction, thus improving the work efficiency.

In the present exemplary embodiment, the reduction in the work efficiency is lowered by changing the task plan to the task plan for transferring the conveyance items at the obstruction site, However, the modification scenario for the task plan is not limited to the method of the present exemplary embodiment. Any modification scenario may be used as long as the modification scenario can lower the reduction in the work efficiency. For example, if an obstruction occurs whose obstruction factor as a step disables the passage of a mobile object, the reduction in the work efficiency may be lowered by adding a work process of replacing a wheel or wheels of the mobile object with a wheel or wheels that can traverse the step. If an obstruction that is caused by the step affects the cargo module or holding mechanism to disable the passage, the cargo module or the holding mechanism may be replaced.

The reduction in the work efficiency may be lowered by replacing the mobile object with another mobile object that is not affected by the obstruction. For example, if an obstruction factor has occurred that has decreased a passage width, the assignment of the task may be changed to a mobile object having a smaller housing size enabling for a smaller minimum passage width. If a passage is impassable due to a step or slip on the passage, the mobile object may be replaced with a mobile object having a mechanism that enables the mobile object to traverse the step or passage that will cause a slip.

A human may be used as a subject of execution of a task. For example, the reduction in the work efficiency may be lowered by enabling the mobile object and the operator to transfer the conveyance items at the obstruction occurrence site. The reduction in the work efficiency may be lowered by changing the assignment of the task execution from the mobile object to the operator.

The task plan may be modified to remove the obstruction. For example, if the obstruction content of “passage impassable” is predicted due to an obstacle, a modification scenario for adding a task of conveying the obstacle from the passage to another point may be determined.

A fourth exemplary embodiment will now be described. In the first exemplary embodiment, the method has been described of determining a modification scenario for lowering the reduction in the work efficiency by avoiding an obstruction that will occur. In the present exemplary embodiment, a method will be described of determining a plurality of plan modification scenarios for lowering a reduction in the work efficiency.

The configuration of the information processing apparatus 200 in the present exemplary embodiment is the same as that of the first exemplary embodiment, and a detailed description is omitted herein.

The processing of the fourth exemplary embodiment is substantially similar to that of the first exemplary embodiment, and a detailed description is omitted herein. A difference from the first exemplary embodiment will be described with reference to the flowchart of FIG. 4. The start of the operation is the same as in the first exemplary embodiment.

In step S407, the plan modification determination unit 206 determines a plurality of modification scenarios based on the obstruction content. The present exemplary embodiment determines at least two of modification scenarios based on the obstruction “passage impassable”. One described in the first exemplary embodiment and the other described in the second exemplary embodiment.

In step S408, the plan update unit 207 updates the plan.

The present exemplary embodiment determines whether the modification scenarios are executable in the order of the modification scenarios input from the plan modification determination unit 206. If the modification scenarios are executable, the plan is output to the holding unit, and the processing then proceeds to step S409.

The subsequent processing is the same as that of the first exemplary embodiment, and a detailed description is omitted herein.

### (Effects)

The method of the present exemplary embodiment more certainly ensures lowering the reduction in the work efficiency.

While the order of the plan modification scenarios output from the plan modification determination unit 206 in the present exemplary embodiment is fixed, the order may be changeable by a user of an apparatus of any exemplary embodiments of the present disclosure.

While the present exemplary embodiment executes the first executable modification scenario input from the plan modification determination unit 206 of the plan modification scenarios, the present disclosure is not limited to this. By estimating the total amount in the task result or the amount of reduction in the task performance based on the working time resulting from the modification of each modification scenario, a plan modification scenario or plan modification scenarios to be executed may be selected based on the order of the plan modification scenarios starting with the least reduction. By estimating the amount of time by which the task end time is shifted backward with respect to the original plan, a plan modification scenario or plan modification scenarios to be executed may be selected based on the order of the plan modification scenarios starting with the smallest shift.

### Other Embodiment

The information determined by the plan modification determination unit 206 may be displayed on a display unit (not illustrated) in one or more of the forms of a diagram, an image, or text. The information may be output to a sound output unit (not illustrated) in the form of sound.

The present disclosure is also implemented by executing the following processing. That is, software (program) for implementing the functions of the above-described exemplary embodiments is supplied to a system or an apparatus via a network or various types of storage media, and a computer (or a CPU or a micro processing unit (MPU)) of the system or the apparatus reads and executes the program. The program recorded in a computer readable recording medium may be provided.

According to the exemplary embodiments of the present disclosure, if there is an obstruction factor that may be an obstruction to the execution of a plan assigned to a mobile object, the reduction in the work efficiency of the mobile object can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-050947, filed Mar. 27, 2024, which is hereby incorporated by reference herein in its entirety.

What is claimed is:

1. An information processing apparatus comprising:
at least one memory storing a program; and
at least one processor that when executing the program causes the information processing apparatus to:
acquire at least one plan assigned to at least one autonomous mobile object;
detect, based on the at least one plan, an obstruction factor that is likely to cause an obstruction to execution of the at least one plan;
predict the obstruction with respect to the at least one plan based on the at least one plan and the obstruction factor;
determine a modification content for the at least one plan based on the obstruction; and
update the at least one plan based on the modification content.

2. The information processing apparatus according to claim 1, wherein the at least one processor further causes the information processing apparatus to move at least one time included in the at least one plan forward or backward.

3. The information processing apparatus according to claim 1, wherein the at least one processor further causes the information processing apparatus to shorten or extend an execution time of the at least one plan.

4. The information processing apparatus according to claim 1,
wherein the at least one autonomous mobile object comprises a plurality of autonomous mobile objects,
wherein the at least one plan comprises a plurality of plans,
wherein the at least one processor further causes the information processing apparatus to acquire a plan assigned to each of the plurality of autonomous mobile objects, respectively, and
wherein the at least one processor further causes the information processing apparatus to determine a modification content for each of the plurality of plans based on the predicted obstruction.

5. The information processing apparatus according to claim 1, wherein the at least one processor further causes the information processing apparatus to determine to modify an executor of the at least one plan.

6. The information processing apparatus according to claim 1,
wherein the at least one plan comprises a plurality of plans, and
wherein the at least one processor further causes the information processing apparatus to select at least one modification content from among modification contents for the plurality of plans based on an amount of reduction in work efficiency of each of the modification contents for the plurality of plans.

7. The information processing apparatus according to claim 1,
wherein the at least one plan comprises a plurality of plans,
wherein the at least one processor further causes the information processing apparatus to determine whether modification contents for the plurality of plans are executable, and
wherein the at least one processor further causes the information processing apparatus to select at least one modification content from among the modification contents for the plurality of plans determined to be executable.

8. The information processing apparatus according to claim 1,
wherein the at least one processor further causes the information processing apparatus to predict an obstruction occurrence time, and
wherein the at least one processor further causes the information processing apparatus to determine the modification content of the at least one plan such that the obstruction occurrence time is not included in an execution time of the at least one plan.

9. The information processing apparatus according to claim 1, wherein the at least one processor further causes the information processing apparatus to predict at least one or more of “passage impassable”, “decrease in friction on a passage floor surface”, “passage difficulty”, or “occupied work area” as the obstruction.

10. An information processing method comprising:
acquiring at least one plan assigned to at least one autonomous mobile object;
detecting, based on the at least one plan, an obstruction factor that is likely to cause an obstruction to execution of the at least one plan;
predicting the obstruction with respect to the at least one plan based on the at least one plan and the obstruction factor;
determining a modification content for the at least one plan based on the obstruction; and
updating the at least one plan based on the modification content.

11. A non-transitory computer-readable storage medium configured to store a computer program for causing a central processing unit to execute a method, the method comprising:
acquiring at least one plan assigned to at least one autonomous mobile object;
detecting, based on the at least one plan, an obstruction factor that is likely to cause an obstruction to execution of the at least one plan;
predicting the obstruction with respect to the at least one plan based on the at least one plan and the obstruction factor;
determining a modification content for the at least one plan based on the obstruction; and
updating the at least one plan based on the modification content.
